(19) United States
(12) Patent Application Publication
(10) Pub. No.: US 2026/0221337 A1
(43) Pub. Date: Jul. 30, 2026

(54) POWER SUPPLY SYSTEM, TRANSFORMER SYSTEM AND ASSEMBLING METHOD THEREOF

(71) Applicant: Hitachi Energy Ltd, Zürich (CH)

(72) Inventors: Weichi Zhang, Beijing (CN); XiaoBo Yang, Beijing (CN); HongXin Jin, Shanghai (CN); Jan Svensson, Västerås (SE); Nicklas Johansson, Västerås (SE)

(21) Appl. No.: 19/148,903

(22) PCT Filed: Mar. 30, 2023
(86) PCT No.: PCT/EP2023/058308

§ 371 Date: Jul. 17, 2025

(30) Foreign Application Priority Data
Jan. 18, 2023 (CN) 202310086067.0

(51) Int. Cl. H01F 38/14; H01F 27/28; H01F 41/02

(52) U.S. Cl. CPC H01F 38/14; H01F 27/28; H01F 41/02

(57) ABSTRACT

A transformer is provided. The transformer includes at least two transformers configured to electrically couple with each other and to supply power to a load via one or more converter modules. One or more transformers of the at least two transformers comprise a high-power secondary winding configured to transfer high power to the load and a low-power secondary winding configured to transfer low power to the load. The at least two transformers comprise at least two primary windings or at least two secondary windings configured to produce outputs that are shifted in phase relative to each other for reducing harmonics on the primary side of the transformer system.

### CROSS REFERENCE TO RELATED APPLICATIONS

This application is a 35 U.S.C. § 371 national stage application of PCT International Application No. PCT/EP2023/058308 filed on Mar. 30, 2023, which in turn claims foreign priority to Chinese Patent Application No. 202310086067.0, filed on Jan. 18, 2023, the disclosures and content of which are incorporated by reference herein in their entirety.

### TECHNICAL FIELD

The present disclosure relates to a transformer system and a method for assembling the transformer system. The present disclosure also relates to a power supply system including the transformer system.

### BACKGROUND

A transformer is a passive component that transfers electrical energy from one circuit to another circuit, or multiple circuits. It is known that a plurality of parallel transformers can be used to supply high power to a high power load.

Rautela Pradeep et al. describe “Design 1-17 Consideration of High Power High Current Twelve Pulse Thyristor Controlled Rectifiers” in 2018 2nd International Conference on Power, Energy and Environment: Towards Smart Technology (ICEPE), IEEE, 1 Jun. 2018, pages 1-6, XP033526345, DOI: 10.1109/EPETSG.2018.8659000, and in particular that high power high current thyristor controlled rectifier are widely used in industries, particularly in electrolysis processes like metal refining, chlorination plants, electroplating, hydrogen production.

Bintz Steffen et al. describe “Parallel Rectifier for Regenerative Hydrogen Production Utilizing a Combination of Thyristor and PWM-based Topologies” in 2018 20^{th} European Conference on Power Electronics and Applications (EPE '18 ECCE EUROPE), EPE ASSOCIATION, 17 Sep. 2018, XP033433214, and in particular that hydrogen as storage medium for fluctuating renewable energy generation requires high current, low voltage rectifiers for grid integration and feeding of the electrolyzer.

However, the reliability and flexibility of such parallel transformers need to be further improved.

### SUMMARY

The invention is defined by the features of the independent claims.

According to an embodiment of the disclosure, a transformer system is provided. The transformer system includes at least two transformers configured to electrically couple with each other and to supply power to a load via one or more converter modules. One or more transformers of the at least two transformers comprise a high-power secondary winding configured to transfer high power to the load and a low-power secondary winding configured to transfer low power to the load. The at least two transformers comprise at least two primary windings or at least two secondary windings configured to produce outputs that are shifted in phase relative to each other for reducing harmonics on the primary side of the transformer system.

According to another embodiment of the disclosure, a power supply system for powering a load is provided. The power supply system includes: a transformer system described above, the transformer system comprising at least two transformers; a modular converter comprising one or more converter modules coupled between the transformer system and the load, each converter module comprising an uncontrolled rectifier and a controllable rectifier; and a controller in communication with the modular converter. One or more transformers of the at least two transformers comprises a high-power secondary winding configured to transfer high power to the load and a low-power secondary winding configured to transfer low power to the load. The high-power secondary winding is coupled with the uncontrolled rectifier and the low-power secondary winding is coupled with the controllable rectifier. The controller is configured to control the controllable rectifier of at least one converter module to provide an adjustable DC current to the load.

According to yet another embodiment, a method for assembling a transformer system is provided. The method includes: selecting at least two transformers, wherein the at least two transformers comprise at least two primary windings or at least two secondary windings configured to be phase shifted relative to each other for reducing harmonics on the primary side of the transformer system; and coupling the at least two transformers to assemble the transformer system, wherein the at least two transformers are coupled between an AC source and the load, and wherein one or more transformers of the at least two transformers comprise a high-power secondary winding configured to transfer high power to the load and a low-power secondary winding configured to transfer low power to the load.

### BRIEF DESCRIPTION OF THE DRAWINGS

The disclosed aspects will hereinafter be described in connection with the appended drawings that are provided to illustrate but not to limit the scope of the disclosure.

FIG. 1 is a block diagram of an exemplary power supply system according to an example of the present disclosure.

FIGS. 2A and 2B are enlarged views of a transformer system of the power supply system of FIG. 1.

FIGS. 3 and 4 schematically show implementations of coupling the transformer system to one or more loads through converter modules.

FIGS. 5~9 show exemplary implementations of the transformer system.

FIGS. 10-14 are schematic diagrams showing exemplary configurations of a transformer of the transformer system.

FIG. 15 is a flowchart of a method for assembling a transformer system according to an embodiment of the present disclosure.

### DETAILED DESCRIPTION

### Overview

Examples of the present disclosure relate to a transformer system including at least two transformers. The at least two transformers are configured to be electrically coupled to each other to power one or more DC loads. One or more of the at least two transformers include a high-power secondary winding configured to transfer high power to the one or DC load and a low-power secondary winding configured to transfer low power to the one or more DC loads. The one or more transformers include at least two primary windings or at least two secondary windings configured to produce outputs that are phase shifted relative to each other for reducing harmonics on the primary side of the transformer system (e.g., harmonics at an AC grid or PCC coupled to the transformer system). The one or more transformers of the transformer system are configured to couple with a modular converter and to provide a DC power supply to the one or more DC loads via the modular converter. In this way, the flatness of the DC power supply can be improved.

According to an example of the present disclosure, the transformer system is designed in consideration of various factors such as harmonics, the rated power and rated current of the modular converter and operating states of the load. Thus, the transformer system can be a “tailor-made” transformer system disposed in a power system for powering the load. Such a transformer system is especially attractive in applications of powering a high power load.

According to an example of the present disclosure, each of the at least two transformers is be coupled to a modular converter including multiple converter modules. Each converter module includes an uncontroller converter and a controllable converter. In this way, the powering of the load can be controlled by controlling the controllable converter.

Advantages of above-mentioned solutions include high system efficiency, low device cost and small size. Also, according to an example of the present disclosure, the DC-DC topology of each converter module can be implemented by using a step-up topology, and can also be implemented by using a step-down topology. Thus, examples of the present disclosure can be extensively applied to various application scenarios.

### Example Power Systems

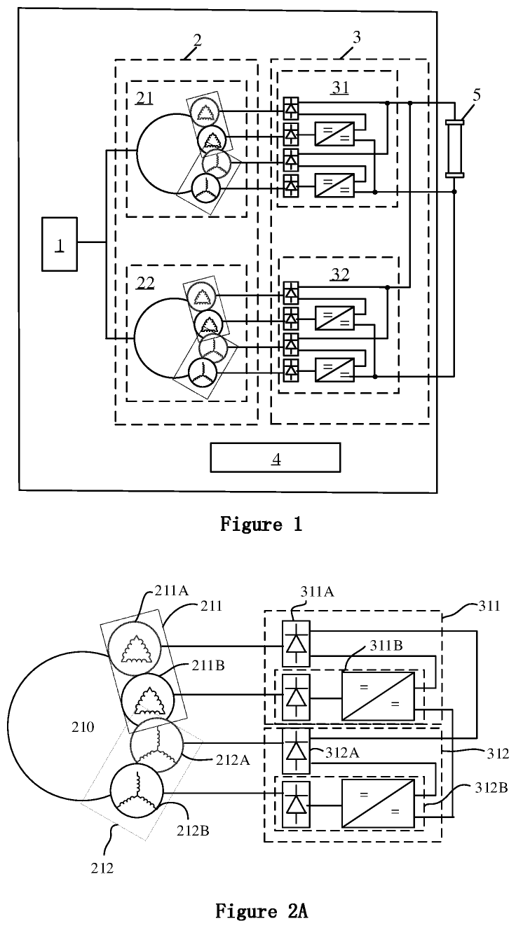

FIG. 1 schematically illustrates a power supply system according to an embodiment of the present disclosure. As shown in FIG. 1, the power supply system includes an AC source 1, a transformer system 2, a converter system 3 and a controller 4. The power supply system is used for powering a DC load 5.

The AC source 1 can be implemented as an AC grid (e.g., a grid-connection from AC transmission or off-grid from renewables) or coupled within a micro-grid. The AC source 1 can also be implemented as a PCC (point of common coupling) of a power system.

The load 5 is a DC load, for example, an electrolyzer for hydrogen production, a power battery of an electric vehicle, or a load of a data center.

The transformer system 2 is coupled between the AC source 1 and the converter system 3 for transferring power between the AC source 1 and the converter system 3. The transformer system 2 includes at least two transfers 21 and 22. The converter system includes at least two modular converters 31 and 32. Each of the at least two transfers 21 and 22 is coupled between the AC source 1 and one of the at least two modular converters 31 and 32. For example, as shown in FIG. 1, the transformer 21 is coupled between the AC source 1 and the modular converter 31, and the transformer 22 is coupled between the AC source 1 and the modular converter 32.

The at least two transformers 21 and 22 are electrically coupled to each other. For example, the primary sides of the at least two transformers are both coupled to the PCC, and the secondary sides of the at least two transformers are coupled to the at least two modular converters 31 and 32.

One or more transformers of the transformer system 2 include a high-power secondary winding and a low-power secondary winding. The high-power secondary winding is configured to transfer high power to one or more DC loads, and the low-power secondary winding is configured to transfer low power to the one or more loads. Here, the high power can be also called first power, the low power can be also called second power, and the first power is greater than the second power. Correspondingly, the high-power secondary winding can also be called a first power secondary winding and the low-power secondary winding can also be called a second power secondary winding.

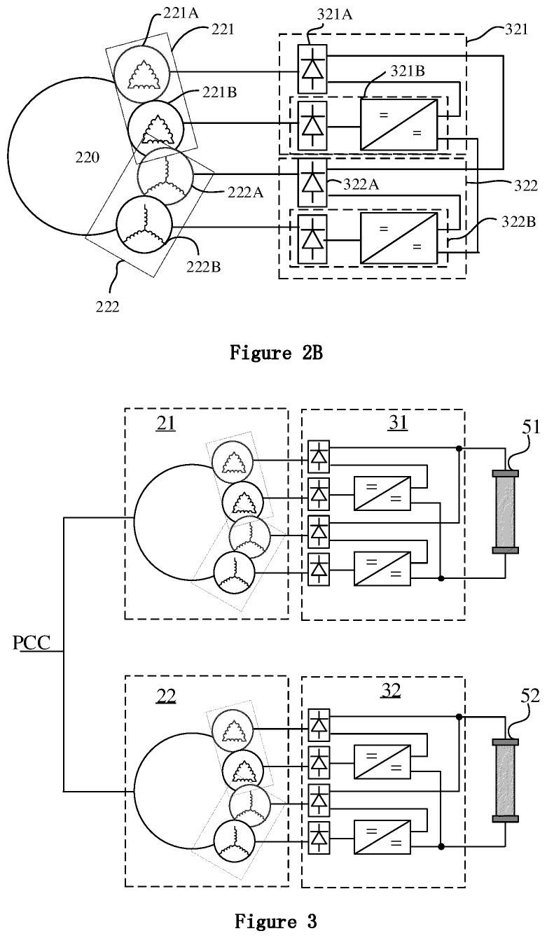

Referring to FIG. 2A, the transformer 21 includes at least two sets 211 and 212 of secondary windings. Each set includes two secondary windings. Taking the set 211 as an example, the set 211 includes a first secondary winding 211A and a second secondary winding 211B. The transformer 21 has a first turns-ratio between the primary winding 210 the first secondary winding 211A and a second turns-ratio between the primary winding 210 and the second secondary winding 211B, so that the power transferred by the first secondary winding 211A is higher than that transferred by the second secondary winding 211B. That is to say, the first secondary winding 211A transfers high power and the second secondary winding 211B transfers low power.

Referring to FIG. 2B, the transformer 22 includes at least two sets 221 and 222 of secondary windings. The arrangement of high-power secondary windings and low-power secondary windings of the transformer 22 is similar to that of the abovementioned secondary windings of the transformer 21, and the description of the arrangement is not repeated here.

One or more transformers of the transformer system 2 include two windings that have a phase shift relative to each other.

In an example, the above-mentioned two windings are two secondary windings that are configured to produce outputs shifted in phase relative to each other. For example, referring to FIG. 2A, both the high-power secondary winding 211A and the low-power secondary winding 211B of the set 211 are configured to produce outputs shifted relative to a reference phase by a first phase angle (e.g.) 30°. Both the high-power secondary winding 212A and the low-power secondary winding 212B of the second set 222 are configured to produce outputs shifted relative to a reference phase by a second phase angle (e.g.) 0°. That is to say, in each set, the two secondary windings are configured to produce outputs shifted in phase relative to each other. For example, in set 211, the high-power secondary winding 211A and the low-power secondary winding 211B are configured to produce outputs shifted in phase relative to each other.

In another example, the above-mentioned two windings are two primary windings that are configured to produce outputs shifted in phase relative to each other. For example, referring to FIGS. 2A and 2B, the primary winding 210 of the transformer 21 and the primary winding 220 of the transformer 22 are configured to produce outputs shifted in phase relative to each other.

The converter system 3 includes at least two modular converters 31 and 32. Each modular converter includes at least two converter modules. For example, the modular converter 31 includes converter modules 311 and 312. Each converter module includes two converters. For example, the converter module 311 includes a first converter 311A and a second converter 311B. The first converter 311A is an uncontrolled converter and is coupled with the high-power secondary winding 211A to transfer a majority of the total power to the load 5. The second converter 311B (i.e., a partial power processing converter) is a controllable converter and is coupled with the low-power secondary winding 211B to transfer only a partial of the total power to the load 5.

Next, taking the first converter module 311 as an example, the implementation of the converter module is introduced with reference to FIG. 2A. Referring to FIG. 2A, in an example, the first converter 311A is implemented as an AC-DC converter and outputs a first DC voltage. The AC-DC converter can be implemented as a diode to output a fixed DC voltage. The AC-DC converter can also be implemented as a thyristor (i.e., a half-controlled device) to output an adjustable DC voltage. The second converter 311B can be implemented as an AC-DC converter and a DC-DC converter connected in series, and outputs a second DC voltage that is an adjustable DC voltage. Alternatively, the second converter 311B can also be implemented as a single stage AC-DC converter and output a second DC voltage that is an adjustable DC voltage.

According to examples of the present disclosure, the number of modular converters of the converter system 3 is equal to the number of transformers of the transformer system 2. That is to say, each transformer is electrically coupled to a modular converter and transfers power to the load 5 via the coupled modular converter. For example, referring to FIG. 1, the transformer system 2 includes two transformers 21 and 22, and the converter system 3 includes two modular converters 31 and 32. The number of transformers of the transformer system 2 is equal to the number of modular converters of the converter system 3. The transformer 21 is coupled with the modular converter 31 and transfers power to the load 5 via the modular converter 31. The transformer 22 is coupled with the modular converter 32 and transfers power to the load 5 via the modular converter 32.

According to examples of the present disclosure, there are various implementations that the transformer system transfers power to the load via a converter system. For example, multiple transformers can supply power to one load via multiple modular converters. Alternatively, multiple transformers can also supply power to individual loads via multiple modular converters.

In an example, DC sides of multiple converter modules can be connected in series or in parallel. The DC sides of multiple converter modules can also be connected in a combination of a parallel connection, a series connection and a series-parallel connection.

In another example, the DC side of each modular converter is respectively coupled to an individual load. For example, referring to FIG. 3, the AC side of the modular converter 31 is coupled to the transfer 21 and the DC side of the modular converter 31 is coupled to the load 51, and thus the transformer 21 can transfer power to the load 51 via the modular converter 31. Similarly, the AC side of the modular converter 32 is coupled to the transfer 22 and the DC side of the modular converter 32 is coupled to the load 52, and thus the transformer 22 can transfer power to the load 52 via the modular converter 32.

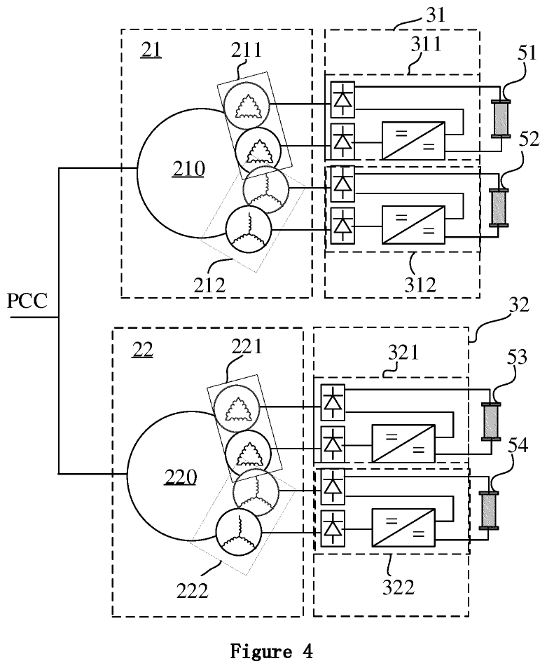

In yet another example, the DC side of each converter module of a modular converter is coupled to a load. That is to say, one modular converter is coupled to individual loads. For example, referring to FIG. 4, the AC side of the converter module 311 is coupled to the set 211, and the DC side of the converter module 311 is coupled to the load 51. The AC side of the converter module 312 is coupled to the set 212, and the DC side of the converter module 312 is coupled to the load 52. In this case, the transformer 21 transfers power to loads 51 and 52 via converter modules 311 and 312. Similarly, the AC side of the converter module 321 is coupled to the set 221, and the DC side of the converter module 321 is coupled to the load 53. The AC side of the converter module 322 is coupled to the set 222, and the DC side of the converter module 322 is coupled to the load 54. In this case, the transformer 22 transfers power to loads 53 and 54 via converter modules 321 and 322.

Returning to FIG. 1, the controller 4 can receive feedback information on the transformer system 2, the modular converter 3 and the load 5 and control the powering of the load 5 based on the feedback information. In this way, the powering of the load 5 can be controlled.

In an example, the feedback information can include the information on the operating state of the load as well as the current, the voltage and power supplied to the load. The feedback information can also include harmonic information.

In an example, the feedback information can include the information on measurements measured at the primary side and/or the secondary side of the transformer system. For example, the measurements include a current and a voltage measured at the primary side of each transformer. The feedback information can also include the information on states of each converter module, such as the voltage or frequency changed by each converter module. The feedback information can also include the information on a load state, such as a load current and a load voltage.

In an example, the load is an electrolyzer and the feedback information includes one or more of: a hydrogen production rate of the electrolyzer, an electrolyzer current, an electrolyzer voltage, an operating efficiency of the electrolyzer, a state of health (SOH) of the electrolyzer, an aging indicator indicating an aging degree of the electrolyzer and an operating state of the electrolyzer (e.g., a light-load state, a full-load state, or an over-load state).

The controller 4 can be implemented in a distributed control system (not shown) including multiple controller nodes. The controller 4 can also be implemented in a centralized control system (not shown) including a high-level controller (e.g., a supervisor controller) and multiple low-level controllers in communication with the high-level controller.

The controller 4 can be implemented by means of hardware or software or a combination of hardware and software, including code stored in a non-transitory computer-readable medium such as a memory and implemented as instructions executed by a processor. Regarding the part implemented by means of hardware, it may be implemented in an application-specific integrated circuit (ASIC), a digital signal processor (DSP), a data signal processing device (DSPD), a programmable logic device (PLD), a field programmable gate array (FPGA), a processor, a controller, a microcontroller, a microprocessor, an electronic unit, or a combination thereof. The part implemented by software may include a microcode, a program code or code segments. The software may be stored in a machine-readable storage medium, such as a memory.

It can be understood that although an example of each transformer including two sets of secondary windings is shown in FIG. 1, the present disclosure is not limited thereto. For example, each transformer can have more sets of secondary windings, for example, each transformer can include three, four or five sets of secondary windings.

### Example Transformer Systems

Examples of the transformer system 2 are introduced in the below.

According to an embodiment of the present disclosure, the transformer system 2 includes a plurality of transformers. Each transformer includes one primary. The primary windings of the plurality of transformers are identically configured to produce no difference in phase angle with respect to each other. That is to say, no phase shift is applied between primary windings. Each transformer includes at least two sets of secondary windings and each set includes a high-power winding and a low-power winding. The two secondary windings (i.e., the high-power secondary winding and the low-power secondary winding) of each set are configured to produce no difference in phase angle with respect to each other.

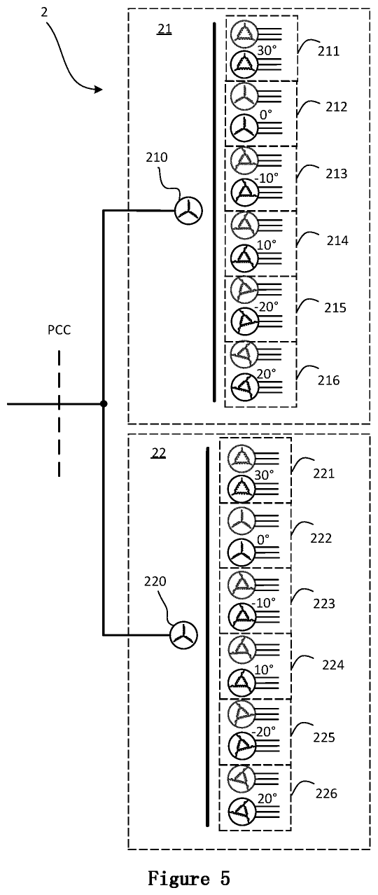

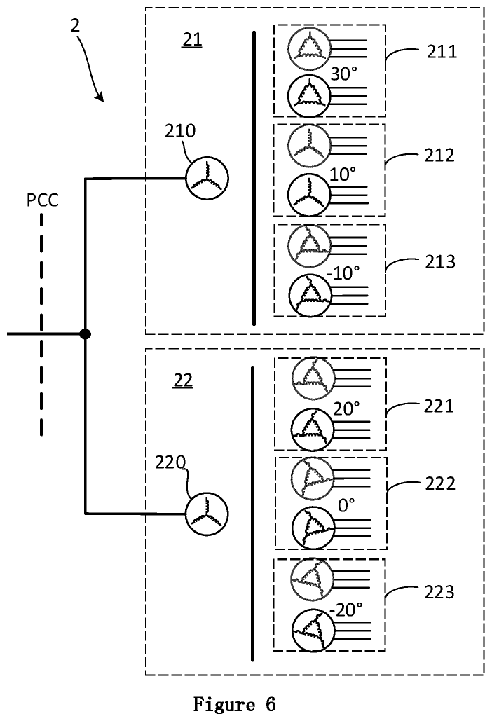

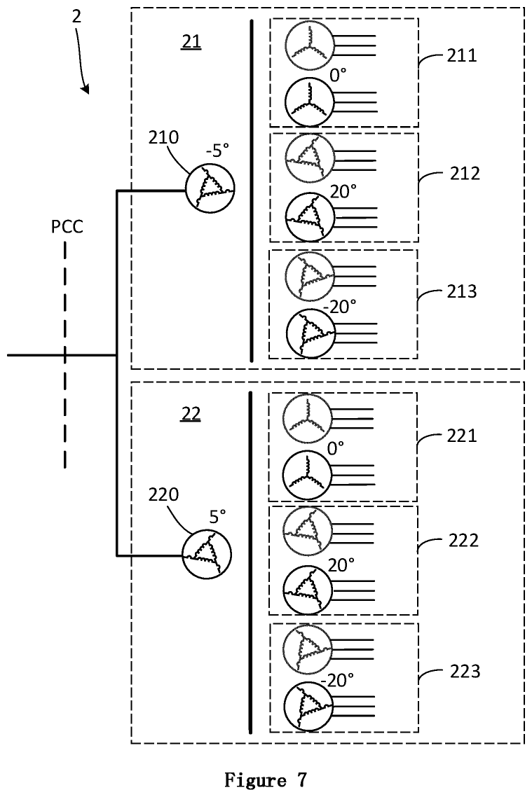

In an example, a plurality of secondary windings of one transformer are configured to produce outputs with one group of phase angles, a plurality of secondary windings of another transformer are configured to produce outputs with another group of phase angles and there is a one-to-one correspondence between each of the phase angles in the one group and one phase angle in another group. In this way, there is no need for too many types of material to make the secondary windings of the transformer system, and thus the cost can be reduced. For example, referring to FIG. 5, the transformer system 2 includes two transformers, i.e., a first transformer 21 and a second transformer 22, and each transformer includes six sets of secondary windings. In this case, the secondary windings of the first set 211 of the first transformer 21 and the secondary windings of the first set 221 of the second transformer 22 are configured to produce no difference in phase angle with respect to each other; the secondary windings of the second set 212 of the first transformer 21 and the secondary windings the second set 222 of the second transformer 22 are configured to produce no difference in phase angle with respect to each other . . . the secondary windings of the sixth set 216 of the first transformer 21 and the secondary windings the sixth set 226 of the second transformer 22 are configured to produce no difference in phase angle with respect to each other.

In another example, phase angles of secondary windings of multiple transformers do not need to have the above-mentioned correspondence, and each transformer is configured to couple with at least one modular converter to produce an output with a predetermined number of pulses. This example has the advantage of a great flexibility in expanding the number of transformers. For example, in the application scenario of maintenance, renovation or repair, one or more transformers is needed to add into the transformer system; however, there might be no transformers that have secondary winding with the above-mentioned corresponding phase angles. In this case, according to this example, as long as a transformer that can realize a predetermined number of pulses can be found, this transformer can be perfect to be added into the transformer system.

According to this embodiment, the transformer system includes a number N (N is an integer greater than or equal to 2) of transformers, each transformer is configured to be coupled with at least one modular converter to produce an n-pulse output, and the transformer system having N transformers are configured to produce an n-pulse output with at least two modular converters.

FIG. 5 shows an example of this embodiment. Referring to FIG. 5, the transformer system includes two transformers 21 and 22 which are implemented in a similar way. Specifically, the primary winding 210 of the transformer 21 and the primary winding 220 of the transformer 22 are configured to produce no difference in phase angle with respect to each other. The transformer 21 has six sets of secondary windings 211-216, and each set of secondary windings includes a high-power secondary winding and a low-power secondary winding. For each set, the high-power secondary winding and the low-power secondary winding are configured to produce no difference in phase angle with respect to each other. For example, as shown in FIG. 5, the high-power secondary winding and the low-power secondary winding of the set 211 both are shifted by 30° relative to a reference zero phase angle. The secondary winding in one set and the secondary winding in another set are configured to produce outputs shifted in phase relative to each other. That is to say, secondary windings have inter-set phase shift. For example, one secondary winding in the set 211 and one secondary winding in another set 212 are configured to produce outputs shifted in phase relative to each other. The configuration of secondary windings of the transformer 22 is the same as that of secondary windings of the transformer 21. In this way, both the transformer 21 and the transformer 22 are configured to couple with at least one modular converter to produce a 36-pulse output, and the transformer system 2 including the transformers 21 and 22 are configured to couple with at least two modular converters to produce a 36-pulse output.

It is noted that the numerical values of the example shown in FIG. 5 (for example, the number of the transformers, the number of sets of secondary windings, and the phase angles) are exemplary and the present disclosure is not limited thereto. For example, the transformer system may also include other numbers of transformers, and each transformer may include other numbers of sets of secondary windings, and the phase-shift angle between secondary windings may also be other values. Moreover, the connection types of the transformer windings may include various types, and are not limited to those shown in FIG. 5.

According to another embodiment of the present disclosure, the transformer system 2 includes a plurality of transformers. Each transformer includes one primary. The primary windings of the plurality of transformers are identically configured to produce no difference in phase angle with respect to each other. That is to say, no phase shift is applied between primary windings. Each transformer includes at least two sets of secondary windings and each set includes a high-power winding and a low-power winding. The two secondary windings (i.e., the high-power secondary winding and the low-power secondary winding) of each set are configured to produce no difference in phase angle with respect to each other. Two secondary windings of different sets are configured to produce outputs shifted in phase relative to each other.

For example, referring to FIG. 6, the transformer system 2 includes two transformers 21 and 22. The transformer 21 includes three sets of secondary windings, i.e., a first set 211, a second set 212 and a third set 213. The transformer 22 includes three sets of secondary windings, i.e., a first set 221, a second set 222 and a third set 223. The secondary winding in the first set 211 of the transformer 21 and the secondary winding in the second set 212 of the transformer 21 are configured to produce outputs shifted in phase relative to each other. Also, the secondary winding in the third set 213 of the transformer 21 and the secondary winding in the first set 221 of the transformer 22 are configured to produce outputs shifted in phase relative to each other.

According to this embodiment, the transformer system includes a number N (N is an integer greater than or equal to 2) of transformers, each transformer is configured to couple with at least one modular converter to produce an n-pulse output, and the transformer system having N transformers are configured to produce an n*N-pulse output with at least two modular converter.

FIG. 6 shows an example of this embodiment. Referring to FIG. 6, the transformer system 2 includes two transformers 21 and 22. The primary winding 210 of the transformer 21 and the primary winding 220 of the transformer 22 are configured to produce no difference in phase angle with respect to each other. Each of the two transformers has three sets of secondary windings. For example, the transformer 21 has three sets 211~213 of secondary windings. The high-power secondary winding and the low-power secondary winding of each set are configured to produce no difference in phase angle with respect to each other. The transformer 22 has three sets 221~223 of secondary windings. The high-power secondary winding and the low-power secondary winding of each set are configured to produce no difference in phase angle with respect to each other.

In the example of FIG. 6, the phase-shifted angle provided by secondary windings are determined in the following way: for each transformer, the phase-shift angle between two secondary windings of different sets is equal to 360°/n, where n is the pulse number of the output of the transformer. Moreover, a secondary winding in a one set of the transformer 21 is configured to produce an output that is shifted in phase relative to that provided by a secondary winding in a corresponding set of the transformer 22 by 360°/M, where M is the pulse number of the output of the transformer system. As described above, M can be equal to n or n*N.

For example, as shown in FIG. 6, the transformer system 2 includes two transformers 21 and 22. Each of two transformers is configured to produce an 18-pulse output, and the transformer system is configured to produce a 36-pulse output. For each transformer, the phase-shift angle between secondary windings in the first set and in the second set or between secondary windings in the second set and in the third set is equal to: 360°/18=20°. Moreover, the phase-shifted angle provided by two secondary windings in corresponding sets of the transformer 21 and transformer 22 is equal to: 360°/36=10°. For example, the phase-shifted angle provided by two secondary windings in corresponding sets 211 and 221 of the transformer 21 and transformer 22 is equal to 10°. Similarly, the phase-shifted angle provided by two secondary windings in corresponding sets 212 and 222 of the transformer 21 and transformer 22 is also equal to 10°. The phase-shifted angle provided by two secondary windings in corresponding sets 213 and 223 of the transformer 21 and transformer 22 is also equal to 10°.

It is noted that the numerical values of the example shown in FIG. 6 (for example, the number of the transformers, the number of sets of secondary windings, and the phase angles) are exemplary and the present disclosure is not limited thereto. For example, the transformer system may also include other numbers of transformers, and each transformer may include other numbers of sets of secondary windings, and the phase-shift angle between secondary windings may also be other values. Moreover, the connection types of the transformer windings may include various types, and are not limited to those shown in FIG. 6.

According to yet another embodiment of the present disclosure, the transformer system 2 includes a plurality of transformers. Each transformer includes one primary. The primary windings of different transformers are configured to produce outputs shifted in phase relative to each other. That is to say, primary windings provide phase shifting. Each transformer includes at least two sets of secondary windings and each set includes a high-power winding and a low-power winding. The two secondary windings (i.e., the high-power secondary winding and the low-power secondary winding) of each set are configured to produce no difference in phase angle with respect to each other. Two secondary windings of different sets are configured to produce outputs shifted in phase relative to each other.

Moreover, a plurality of secondary windings of one transformer are configured to produce outputs with one group of phase angles, a plurality of secondary windings of another transformer are configured to produce outputs with another group of phase angles and there is a one-to-one correspondence between each of the phase angles in the one group and one phase angle in another group. For example, referring to FIG. 7, the transformer system 2 includes two transformers 21 and 22. Each transformer includes three sets of secondary windings. In this case, the secondary winding in the set 211 of the transformer 21 and the secondary winding in the set 221 of the transformer 22 are configured to produce no difference in phase angle. Similarly, the secondary winding in the set 212 of the transformer 21 and the secondary winding in the set 222 of the transformer 22 are configured to produce no difference in phase angle. The secondary winding in the set 213 of the transformer 21 and the secondary winding in the set 223 of the transformer 22 are configured to produce no difference in phase angle.

According to this embodiment, the transformer system includes a number N (N is an integer greater than or equal to 2) of transformers, each transformer is configured to couple with at least one modular converter to produce an n-pulse output, and the transformer system having N transformers are configured to produce an n*N-pulse output with at least two modular converter.

FIG. 7 shows an example of this embodiment. Referring to FIG. 7, the transformer system 2 includes two transformers 21 and 22. The primary winding 210 of the transformer 21 and the primary winding 220 of the transformer 22 are configured to produce outputs shifted in phase relative to each other. Each transformer has three sets of secondary windings. For example, the transformer 21 has three sets 211~213 of secondary windings. The high-power secondary winding and the low-power secondary winding in each set are configured to produce no difference in phase angle. The transformer 22 has three sets 221~223 of secondary windings. The high-power secondary winding and the low-power secondary winding in each set are configured to produce no difference in phase angle. Each of the transformer 21 and the transformer 22 is configured to couple with at least one modular converter to produce an 18-pulse output, and the transformer system 2 including the transformers 21 and 22 are configured to couple with at least two modular converters to produce a 36-pulse output.

It is noted that the numerical values of the example shown in FIG. 7 (for example, the number of the transformers, the number of sets of secondary windings, and the phase angles) are exemplary and the present disclosure is not limited thereto. For example, referring to FIG. 8, the transformer system 2 includes four transformers 21~24, and primary windings 210~240 of the four transformers are phase shifted relative to each other. Each of the four transformers 21~24 is configured to couple with at least one modular converter to produce an 18-pulse output, and the transformer system 2 including the four transformers 21~24 is configured to couple with at least two modular converters to produce a 48-pulse output. Moreover, the connection types of the transformer windings may include various types, and are not limited to those shown in FIGS. 7 and 8.

According to yet another embodiment of the present disclosure, the transformer system 2 includes two transformers. Each transformer includes one primary. The primary windings of the two transformers are configured to produce no difference in phase angle. That is to say, no phase shifting is provided by primary windings. One transformer has a larger capacity than the other one. Said one transfer having a larger capacity includes a plurality of high-power secondary windings, and said the other transformer having a smaller capacity includes a plurality of low-power secondary windings.

According to this embodiment, each transformer is configured to couple with at least one modular converter to produce an n-pulse output, and the transformer system having two transformers are configured to produce an n-pulse output with at least two modular converter.

FIG. 9 shows an example of this embodiment. Referring to FIG. 9, the transformer system 2 includes two transformers 21 and 22. The primary winding 210 of the transformer 21 and the primary winding of the transformer 22 are configured to produce no difference in phase angle. The transformer 21 has six high-power secondary windings 211A~216A and those secondary windings are configured to produce outputs shifted in phase relative to each other. The transformer 22 has six low-power secondary windings 211B~216B and those secondary windings are configured to produce outputs shifted in phase relative to each other. Each transformer is configured to couple with at least one modular converter to produce a 36-pulse output, and the transformer system having two transformers are configured to produce a 36-pulse output with at least two modular converter.

In an example, each of the six high-power secondary winding 211A~216A of the transformer 21 and a corresponding one of the six low-power secondary winding 211B~216 B of the transformer 22 are configured to produce no difference in phase angle.

It is noted that the numerical values of the example shown in FIG. 9 (for example, the number of the transformers, the number of sets of secondary windings, and the phase angles) are exemplary and the present disclosure is not limited thereto. For example, the transformer system may also include other numbers of transformers, and each transformer may include other numbers of sets of secondary windings, and the phase-shift angle between secondary windings may also be other values. Moreover, the connection types of the transformer windings may include various types, and are not limited to those shown in FIG. 9.

### Example Configurations of Transformer Windings

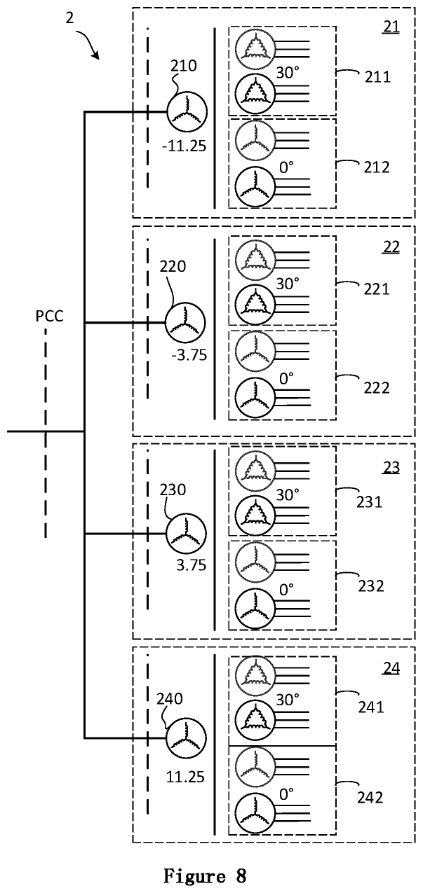

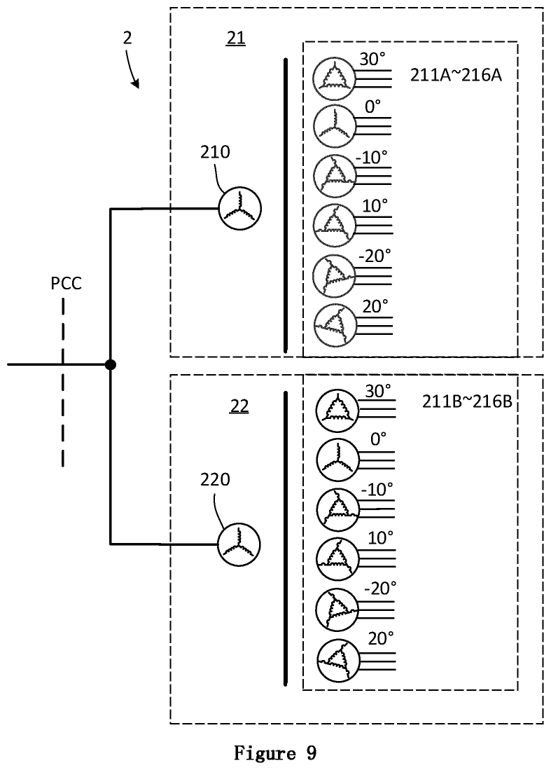

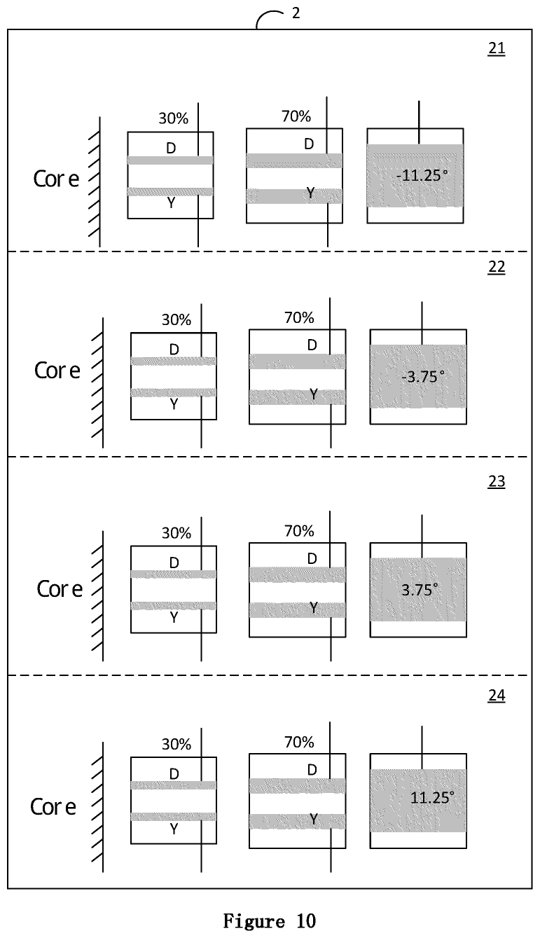

FIG. 10 shows an exemplary arrangement of primary windings and secondary windings of transformers in the transformer system. For clarity, the winding arrangement of FIG. 10 is illustrated by using the transformer system shown in FIG. 8 as an example.

Referring to FIG. 10, each transformer of the transformer system 2 is arranged such that, with the iron core as a center (i.e., the innermost), low-power secondary windings, high-power secondary windings and a primary winding are arranged sequentially from the inside to the outside. One or more insulation layers are arranged between the low-power secondary windings and the high power-secondary windings. Also, one or more insulation layers are arranged between the high power-secondary windings and the primary winding. Such an arrangement is advantageous. For example, the number of taps on the secondary side of each transformer is less, and it is easy to draw those taps directly from secondary windings. Also, by placing the primary winding on the outermost side, the transformer is small and cost-effective.

Next, taking the transformer 21 shown in FIG. 5 as an example, examples of the configuration of primary and secondary windings will be described below.

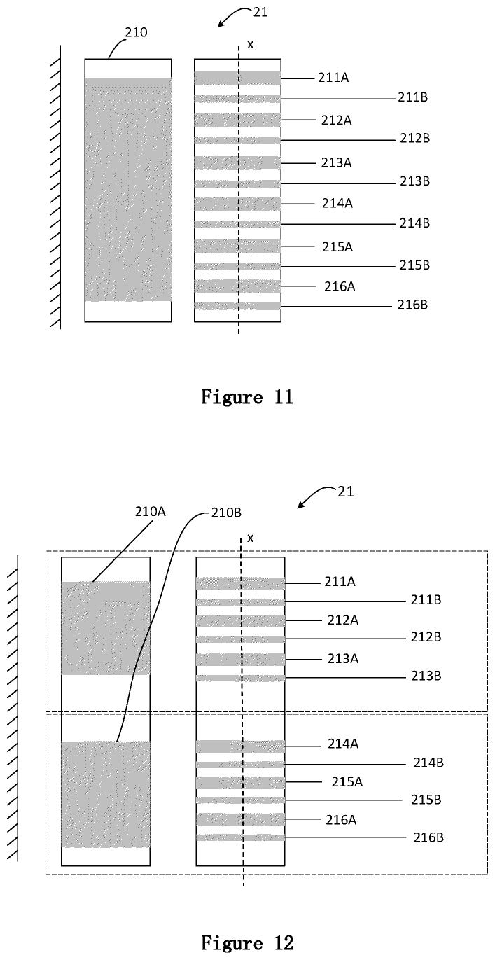

FIG. 11 shows an example of the transformer 21. As shown in FIG. 11, the transformer 2 has one primary winding 210. On the secondary side, the high-power secondary winding and the low-power secondary winding are arranged alternatively along an axial direction (as shown by the dotted line in FIG. 11) of the secondary windings. For example, the secondary windings are arranged along the axial direction in the following sequence: high-power secondary winding 211A->low-power secondary winding 211B->high-power secondary winding 212A->low-power secondary winding 212B . . . high-power secondary winding 216A->low-power secondary winding 216B. In the axial direction, the height of the primary winding 210 corresponds to the overall height of the secondary windings. For example, half the height of the primary winding 210 is aligned with half the overall height of the secondary windings.

FIG. 12 shows another example of the transformer 21. As shown in FIG. 12, the transformer 21 includes two primary windings 210A and 210B. Each of the two primary windings corresponds to half of the transformer capacity. That is to say, each of the two primary windings can transfer power equal to half of the transformer capacity. The secondary windings are arranged in two sections. Each section corresponds to one primary winding and receives power transferred from said one primary winding. For example, one of the two sections is aligned in the axial height with one primary winding 210A and the other of the two sections is aligned in the axial height with the other primary winding 210B. In each of the two sections, the high-power secondary winding and the low-power secondary winding are arranged alternatively along an axial direction (as shown by the dotted line in FIG. 12) of the secondary windings. For example, one section of secondary windings includes high-power secondary windings 211A~213A and low-power secondary windings 211B~213B, and these secondary windings are arranged along the axial direction in the following sequence: high-power secondary winding 211A->low-power secondary winding 211B->high-power secondary winding 212A->low-power secondary winding 212B->high-power secondary winding 213A->low-power secondary winding 213B. Another section of secondary windings includes high-power secondary windings 214A~216A and low-power secondary windings 214B~216B, and these secondary windings are arranged along the axial direction in the following sequence: high-power secondary winding 214A->low-power secondary winding 214B->high-power secondary winding 215A->low-power secondary winding 215B->high-power secondary winding 216A->low-power secondary winding 216B.

According to yet another example (not shown) of the transformer 21, the transformer 21 includes three primary windings. Each of the three primary windings corresponds to one third of the transformer capacity. The secondary windings are arranged in three sections. Each section corresponds to one primary winding and receives power transferred from said one primary winding. For example, each of the three sections is aligned in the axial height with one primary windings. In each of the three sections, the high-power secondary winding and the low-power secondary winding are arranged alternatively along an axial direction of the secondary windings.

The examples of the transformer including two or more primary windings are helpful for the ampere-turn balance of transformer windings in the event of a fault (e.g., an open-circuit fault) occurring in at least one converter coupled to the transformer. For example, when an open-circuit fault occurs in at least one converter, the ampere-turn balance of transformer windings can exceed a predetermined level without being too bad. In other words, when the primary side of the transformer includes two or more primary windings, such a transformer has a better ampere-turn balance.

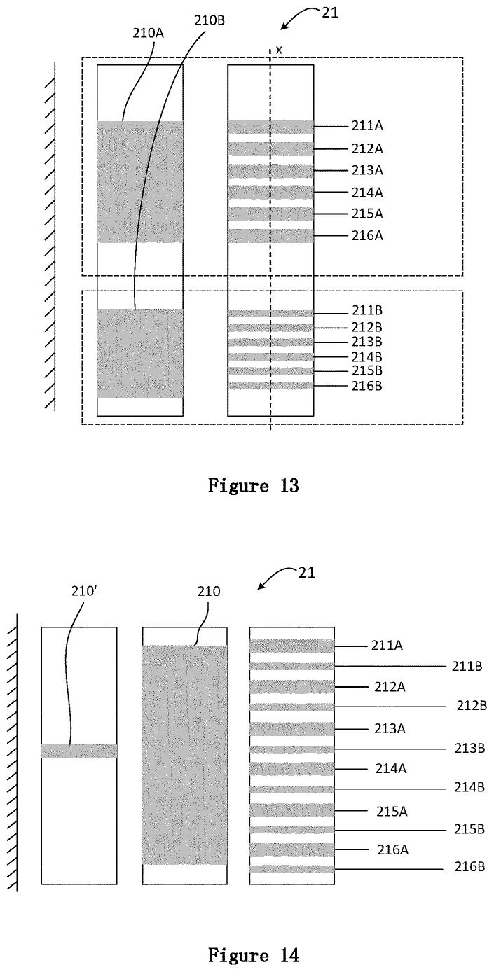

FIG. 13 shows yet another example of the transformer 21. As shown in FIG. 13, the transformer 21 includes two primary windings 210A and 210B. These two primary windings correspond to different ratios of the transformer capacity. For example, one of the two primary windings is capable of transferring more power than the other. The secondary windings are arranged in two sections. Each section corresponds to one of the two primary windings. One of the two sections includes high-power secondary windings. For example, high-power secondary windings 211A~216A are included in said one section and arranged along the axial direction in the following sequence: high-power secondary winding 211A->high-power secondary winding 212A . . . high-power secondary winding 216A. The other of the two sections includes low-power secondary windings. For example, low-power secondary windings 211B~216B are included in said the other section and arranged along the axial direction in the following sequence: low-power secondary winding 211B->low-power secondary winding 212B . . . low-power secondary winding 216B.

FIG. 14 shows yet another example of the transformer 21. In this example, the transformer 21 further includes an additional winding 210′ for powering accessories (e.g., a cooling device, a heating device and a pump) of the power supply system.

In addition, in an example, the transformer 21 can further include a tap changer (not shown). The tap changer includes multiple switchable tap positions. The change of the tap position can be realized through the control of the controller, or by changing the tap position manually, so as to transfer power of different voltage levels from the primary side to the secondary side. In this way, the flexibility of powering the load can be further increased, so as to meet customized demands for powering the load.

### Parameters of Transformer Systems

According to examples of the present disclosure, the transformer system is disposed in a power supply system for powering a load. Such a transformer system is provided based on the following factors: various cases for harmonics of the power supply system, a power supply demand of an end load, the rated power and rated current of each converter of the power supply system. In this way, the transformer system can be “perfect” in the power supply system to transfer power to the load. Examples of parameters of the transformer system are described below.

First, a minimum value of the pulse number n of the transformer system is determined based on the worst-case for harmonics, i.e., a situation where the power supply system has the worst harmonic performance. That is to say, the minimum value of the pulse number of the transformer system is determined based on the minimum-load-rate situation. This is because in various operating states of the power supply system, the worst-case for harmonics should meet the harmonic requirement of the grid coupled with the AC source (for example, the harmonic requirement of the PCC on the grid side). The worst-case for harmonics can be different in different application scenarios. Examples of the worst-case for harmonics are introduced below.

In an example, the worst-case for harmonics of the power supply system occurs at the minimum load rate. For example, the total harmonic distortion of the power supply system when the power supply system is operating at the minimum load rate should be less than a predetermined level (e.g., the predetermined level is predefined based on the harmonic requirement of the grid coupled to the AC or based on the harmonic requirement of the PCC point).

It is noted that the load rate refers to the ratio of the operating power of the load to the rated power of the load. For the load of an electrolyzer, the rated power refers to the product of its maximum current and maximum voltage. For example, if the operating power of the load is equal to the rated power, the load rate is 100%. If the operating power of the load is 30% of the rated power, the load rate is 30%. If the operating power of the load is greater than the rated power, the load rate is greater than 100%. In an example, the load rate can be used to define the light-load state (for example, the load rate is less than 50%), the full-load state (for example, the load rate is 100%) and the over-load state (for example, the load rate is greater than 100%).

For clarity, taking the load of an electrolyzer as an example, the above-mentioned determination of the minimum value of the pulse number is introduced. It is noted that the numerical values used in the following description are illustrative. For example, a 5 MW (1000V, 5000 A) electrolyzer is operating at a minimum load rate of 20% (i.e., 1 MW), and the harmonic requirement is that the total harmonic distortion is below 3%. Based on the minimum load rate and the harmonic requirement, the minimum value of the pulse number is determined to be a 36-pulse. That is to say, a 36-pulse transformer system is provided to meet the harmonic requirement.

In another example, the transformer system includes two transformers and the worst-case for harmonics of the power supply system occurs when only one transformer is operating. The minimum value of the pulse number of the transformer system is determined based on the only-one-transformer-operating situation.

For clarity, this example is further introduced with reference to FIG. 6. The transformer system shown in FIG. 6 includes two transformers. Each of the two transformers is implemented as a 18-pulse configuration and the two transformers together form a 36-pulse configuration. When only one transformer is operating (e.g., one of the two transformers is running at full load and the other of the two transformers is running at no load), i.e., the transformer system is operating with a 18-pulse transformer, the total harmonic distortion caused by the 18-pulse transformer should be less than a predetermined level (e.g., the predetermined level is predefined based on the harmonic requirement of the PCC point). Similarly, in another example, the transformer system is implemented as a 24-pulse configuration including two 12-pulse transformers, and total harmonic distortion caused by one 12-pulse configuration (i.e., the situation where only one transformer is operating) exceeds the predetermined level, in this case, the transformer system can be changed to a 48-pulse configuration including two 24-pulse transformers. In this case, if only one transformer is operating, the transformer system will operate with a 24-pulse configuration and can meet the harmonic requirement. In this case, a 48-pulse transformer system is provided.

In yet another example, the minimum value of the pulse number of the transformer system is determined based on a combination of the above-mentioned situations. For example, the transformer system includes two transformers and the worst-case for harmonics of the power supply system occurs when only one transformer is operating at the minimum load rate. In this case, the minimum value of the pulse number of the transformer system is determined based on such a combined situation, and a transformer system which is able to produce an output with the determined pulse number when coupled with converters is provided

In addition, in an example, the minimum value of the pulse number is determined further based on a redundancy value. In this example, the pulse number of the transformer system is equal to a sum of the minimum value determined based on the worst-case for harmonics and the redundancy value. This enables the transformer system capable of operating well in fault situations or unstable situations. This can also reduce the total harmonic distortion of the power supply system below a predetermined level.

The redundancy value can be calculated based on experimental results and/or a mathematical model. For example, an optimization model for optimizing harmonic performance in different application scenarios is created previously and stored in the controller. The redundancy value can be obtained by using this optimization model.

Next, other parameters of the transformer system such as the number of transformers and the number of secondary winding sets of each transformer can be determined such that transformer system can produce an output with the above-mentioned minimum pulse number.

In an example, the transformer system is implemented using the configuration of FIG. 5, and it is determined that the transformer system can produce an output with the minimum pulse number of 36. In this case, each transformer of the transformer system should be implemented as a 36-pulse transformer, and each transformer should have six sets of secondary windings.

In another example, the transformer system is implemented using the configuration of FIG. 6, and it is determined that the transformer system can produce an output with the minimum pulse number of 36. In this case, each transformer of the transformer system should be implemented as an 18-pulse transformer, and each transformer should have three sets of secondary windings.

In yet another example, the transformer system is implemented using the configuration of FIG. 7, and it is determined that the transformer system can produce an output with the minimum pulse number of 36. In this case, each transformer of the transformer system should be implemented as an 18-pulse transformer, and each transformer should have three sets of secondary windings.

In yet another example, the transformer system is implemented using the configuration of FIG. 8, and it is determined that the transformer system can produce an output with the minimum pulse number of 48. In this case, each transformer of the transformer system should be implemented as a 12-pulse transformer, and each transformer should have two sets of secondary windings.

In yet another example, the transformer system is implemented using the configuration of FIG. 9, and it is determined that the transformer system can produce an output with the minimum pulse number of 18. In this case, each transformer of the transformer system should be implemented as an 18-pulse transformer, and each transformer should have six sets of secondary windings.

In an example, for each transformer, the number N of sets of secondary windings is further determined based on the rated power and rated current of each converter module, a power supply demand of the load, and modular design requirements of the modular converter.

In an example, for each transformer, the number N of sets of secondary windings can be increased. For example, if the number of sets of secondary windings is determined to be six, this number can be increased to twelve. That is to say, six sets of secondary windings are expanded to twelve sets. In this way, the voltage, current and power that each converter module needs to withstand can be reduced, so that low-cost and more power electronic devices can be selected.

Next, the phase shifting provided by secondary windings can be determined for encouraging improved transformer economy. For example, in the case that multiple phase-shifted angles can be adapted, the most economical one will be selected.

Next, the phase shifting provided by the windings is introduced. For example, when a winding adopts the delta connection, the phase shift is provided as follows: the winding includes a basic winding and a phase shifting winding, and the basic winding and the phase shifting winding have different turns. A composite voltage is obtained after the basic winding and the phase shifting winding are connected, and the phase angle of the winding voltage is different under different connections. It is noted that the ZAGZIG can also achieve phase shifting based on the above-mentioned principle through a Z connection.

It is noted that although specific connections of primary and secondary windings are shown in figures, this should be understood as an example, and the present disclosure is not limited thereto.

### Example Methods

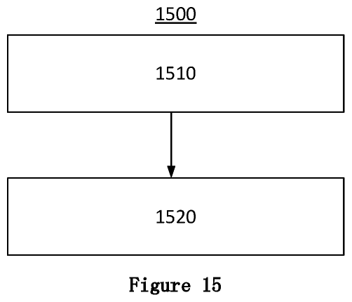

FIG. 15 shows a method 1500 for assembling the transformer system 2. The above description about the transformer system 2 is also applicable here, and will not be repeated.

At block 1510, at least two transformers are selected. The at least two transformers include at least two primary windings or at least two secondary windings configured to be phase shifted relative to each other for reducing harmonics on the primary side of the transformer system.

At block 1520, the at least two transformers are coupled together to assemble the transformer system. The at least two transformers are coupled between an AC source and the load. One or more transformers of the at least two transformers include a high-power secondary winding configured to transfer high power to the load and a low-power secondary winding configured to transfer low power to the load.

The above-mentioned assembling method is advantageous. For example, multiple transformers supplied by different suppliers or by the same supplier can be used. The multiple transformers can be transported to the assembly location from different locations and then assembled at the assembly location. Moreover, obtaining a transformer system by assembling multiple transformers would have less system requirements than that required by single transformer design, thereby shortening the production cycle and reducing costs.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalent transformations to the elements of the various aspects of the present disclosure, which are known or to be apparent to those skilled in the art, are intended to be covered by the claims.

1. A transformer system, comprising:
at least two transformers configured to electrically couple with each other and to supply power to a load via one or more converter modules, wherein
the at least two transformers comprise at least two primary windings or at least two secondary windings configured to produce outputs that are shifted in phase relative to each other for reducing harmonics on the primary side of the transformer system,
each of the at least two transformers comprises two or more sets of secondary windings,
each set comprises a high-power secondary winding and a low-power secondary winding,
the high-power secondary winding and the low-power secondary winding in each set are configured to produce no difference in phase angle with respect to each other, and
two secondary windings in different sets are configured to produce a difference in phase angle with respect to each other.

2. The transformer system of claim 1, wherein each of the at least two transformers is configured to couple with a common AC source; and wherein the at least two transformers are configured identically to produce no difference in phase angle with respect to each other.

3. The transformer system of claim 1, wherein each of the at least two transformers is configured to couple with a common AC source; and wherein the at least two transformers are configured to produce a difference in phase angle with respect to each other.

4. (canceled)

5. The transformer system of claim 1, wherein one transformer of the at least two transformers comprises a plurality of high-power secondary windings and the other transformer of the at least two transformers comprises a plurality of low-power secondary windings.

6. The transformer system of claim 5, wherein the plurality of high-power secondary windings are configured to produce outputs that are phase-shifted relative to each other, and the plurality of low-power secondary windings are configured to produce outputs that are phase-shifted relative to each other; and wherein each of the plurality of high-power secondary windings and a corresponding one of the plurality of low-power secondary windings are configured to produce no difference in phase angle with respect to each other.

7. The transformer system of claim 5, wherein said one transformer has a first capacity, and said the other transformer has a second capacity which is less than the first capacity.

8. The transformer system of claim 1, wherein the transformer system comprises a number N of transformers, each transformer is configured to couple with at least one converter module to produce an n-pulse output, and the transformer system is configured to produce an n*N-pulse output with at least two converter modules.

9. The transformer system of claim 1, wherein the transformer system comprises a number N of transformers, each transformer is configured to couple with at least one converter module to produce an n-pulse output, and the transformer system is configured to produce an n-pulse output with at least two converter modules.

10. The transformer system of claim 1, wherein the transformer system is configured to couple with at least two converter modules to produce an n-pulse output, and wherein the minimum value of the number n is provided based on a situation where a power supply system in which the transformer system is disposed has the worst-case for harmonics.

11. The transformer system of claim 10, wherein the minimum value of the number n is provided further based on a redundancy value for reducing the total harmonic distortion of the power supply system below a pre-determined level.

12. The transformer system of claim 10, wherein the number of sets of secondary windings of each transformer is provided based on the minimum value of the number n.

13. The transformer system of claim 12, wherein the number of sets of secondary windings of each transformer is provided further based on the rated current and rated power of each of the one or more converter modules.

14. The transformer system of claim 1, wherein the phase-shifted angle produced by the at least two primary windings or the at least two secondary windings is provided based on the minimum value of the number n.

15. The transformer system of claim 14, wherein the phase-shifted angle produced by the at least two primary windings or the at least two secondary windings is provided further based on the most economical one of multiple selectable phase-shifted angles.

16. A power supply system for powering a load, comprising:
a transformer system of claim 1, the transformer system comprising at least two transformers;
one or more converter modules coupled between the transformer system and the load, each converter module comprising an uncontrolled rectifier and a controllable rectifier; and
a controller in communication with the one or more converter modules, wherein
one or more transformers of the at least two transformers comprises a high-power secondary winding configured to transfer high power to the load and a low-power secondary winding configured to transfer low power to the load;
the high-power secondary winding is coupled with the uncontrolled rectifier and the low-power secondary winding is coupled with the controllable rectifier; and
the controller is configured to control the controllable rectifier of at least one converter module to provide an adjustable DC current to the load.

17. A method for assembling a transformer system, comprising:
selecting at least two transformers, wherein each of the at least two transformers comprises two or more sets of secondary windings, and each set comprises a high-power secondary winding and a low-power secondary winding, and wherein the high-power secondary winding and the low-power secondary winding in each set are configured to produce no difference in phase angle with respect to each other, and two secondary windings in different sets are configured to produce a difference in phase angle with respect to each other;
wherein the at least two transformers comprise at least two primary windings or at least two secondary windings configured to produce a difference in phase angle with respect to each other for reducing harmonics on a primary side of the transformer system; and
coupling the at least two transformers together to assemble the transformer system, wherein the at least two transformers are coupled between an AC source and a load.
